(19) United States
(12) Patent Application Publication
(10) Pub. No.: US 2006/0061603 A1
(43) Pub. Date: Mar. 23, 2006

(54) Subfield driving pixels in a display device

(75) Inventors: Derk Andre Kort, Eindhoven (NL); Jeroen Van Velzen, Best (NL); Roel Van Woudenberg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,233

(22) PCT Filed: Nov. 3, 2003
(86) PCT No.: PCT/IB03/05030

§ 371 Date: May 24, 2005

(30) Foreign Application Priority Data
Nov. 29, 2002 (EP) 02080003.3

(51) Int. Cl. G09G 5/10

(52) U.S. Cl. 345/691

(57) ABSTRACT

A method for driving pixels in a display device with an image signal is disclosed wherein the image signal comprises grey level information of an image to be rendered by the display device. The method comprises: dividing the image signal into sections, each section having a duration of a section period; dividing the section period into a plurality of adjacent, weighted sub-section periods; selecting for each of the pixels to be driven during the section period a sequence of adjacent sub-section periods in dependence on the grey level information, the selectable sequences lacking a common starting and ending point; driving the pixels during the sequences adjacent sub-section periods. The method may be applied to displays driven by a pulse width modulated signal, such as sub-field as well as sub-line operated displays including plasma display panels, dynamic foil displays and passive displays.

The present invention relates to a method for driving a pixel in a display device.

The invention also relates to a display device using such a method.

It is known to implement gray scales in displays by means of pulse width modulation of an image signal, whereby a line period, available to drive the pixels in a line of a display frame of image data, is divided into N sub-line periods of equal duration. This is illustrated in FIG. 1 for the gray levels GL having a value 4, 5 and 6. During driving, a pixel is turned on at the beginning of the line period and maintained on during a number of consecutive sub-line periods required to reach the desired gray scale level. As the sub-line periods are equally long, each of the sub-lines provides an equal contribution to the light emitted during that line period, or, in other words, each sub-line has an equal weight W. This is indicated by means of an equal value 1 of the weight W of each sub-field in FIG. 1. After these sub-line periods, the pixel is switched OFF, and remains OFF during the remainder of the frame.

However, this approach only allows N+1 gray scale levels, where N is the number of sub-lines.

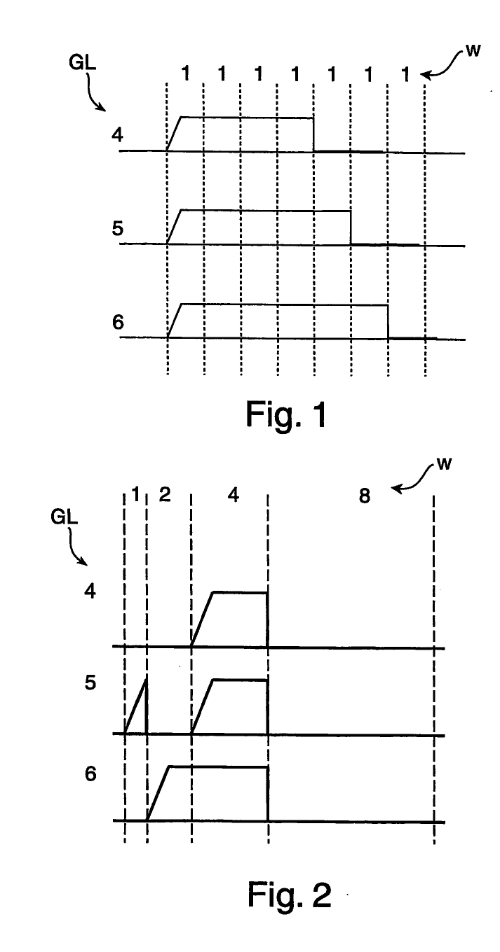

An alternative technique is achieved by weighting the sub-lines, i.e. assigning different lengths to them, and using combinatorial logic to achieve different luminance levels. Any number of the N weighted sub-lines are thus combined to form a total period of the desired length. By choosing binary weights W, this method is highly efficient. The binary weights W are normally assigned straightforwardly from a least significant bit LSB to a most significant bit MSB, as shown in FIG. 2, where again the values 4, 5 and 6 of the gray levels GL are depicted.

While this solution leads to an increase of the number of available gray scale levels (2^{N} for N sub-lines), it also requires an increased number of switching actions, as several state changes (from OFF to ON and from ON to OFF) may be required during a field.

Also, the current through the pixel has a certain rise time, which is illustrated in FIG. 1. As is clear from FIG. 2, when different sub-lines are combined to achieve the different levels, the number of rise times can vary between gray levels. This causes non-linearities in the gray scale, as the luminance is proportional to the integral of the light emission during the sub-lines. For example, while the levels represented by the values 4 and 6 only require one rise time, the level represented by the value 5 requires two rise times.

While the above focused on sub-line addressing, such as is generally applied in PLED displays, similar problems arise in sub-field addressing, such as is generally applied in plasma displays. With binary weighted sub-fields it must be possible to perform ON-addressing and OFF-addressing for each sub-field, as (almost) any sub-field potentially can represent the beginning or the end of an addressing period. This is not efficient, as ON addressing in many cases takes a longer time than OFF addressing.

An object of the present invention is to provide an improved pulse width modulated driving method for providing gray scale levels in a display device, thereby avoiding or at least mitigating the above problems. The invention is defined by the independent claims. The dependent claims define advantageous embodiments. This object is achieved by a method for driving pixels in a display device with an image signal, the image signal comprising gray level information of an image to be rendered by the display device, the method comprising:
dividing the image signal into sections, each section having a duration of a section period;
dividing the section period into a plurality of adjacent, weighted sub-section periods;
selecting for each of the pixels to be driven during the section period a sequence of adjacent sub-section periods in dependence on the gray level information, the selectable sequences lacking a common starting and ending point;
driving the pixels during the sequences of adjacent sub-section periods.

The sections may be frames or fields of the image, while the section period is the frame period or the field period, respectively. In such a case a sub-section is a sub-field.

Alternatively, the sections may be lines of an image frame, while the section period is the line period. In such a case the sub-section is a sub-line. The sections may also be any other part of a frame, for example, a group of lines. So, the method according to the invention advantageously can be used in line-at-a-time operated displays as well as sub-field operated displays.

According to the invention, only one rise-time is present when a pixel is driven during a frame period, so, the loss of light output during the rise time is the same for all gray scale levels. The cost of this advantage is a slightly lower number of available levels than in complete binary combinatory logic (with the same number of sub-fields).

As sequences are formed by a selection of adjacent sub-section periods, a starting point of a sequence depends on the first sub-section period of the sequence and an ending point depends on the last sub-section period of the sequence. In other words, the selectable sequences do not have a common starting and ending point.

The invention also allows a reduction of the number of discharge/charge actions, which in many types of displays (e.g. plasma displays) results in lower dissipation and increased lifetime for the pixel.

In displays of the type described in WO 99/28890, referred to as Dynamic Foil Displays, the invention may also be advantageously implemented. For example, the lifetime of such a foil display is improved, since the frequency of foil switching is reduced by applying schemes with contiguous light generation as compared to schemes where the foil is switched more than once from the passive plate to the active plate and back in one frame.

The invention may also be applied to color displays. In that case the method may be applied to each of the color components of the image signals, each color component containing “gray level” information for corresponding types of color pixels.

When a linear range of gray levels is desired, the respective weights, or in other words the respective durations of the subsequent sub-section periods, are chosen such that for any two successive gray levels the corresponding sequences of adjacent sub-section periods have an equal time difference. Preferably, the difference is equal to the weight of the smallest sub-section, typically normalized as “1”. This leads to a complete range of gray levels, just as in the binary coding scheme according to prior art, but with only one rise time per frame.

It may be advantageous that the three final sub-sections in the section have the weights “4:1:2”. This provides for a good starting point and further suitable weights can be appended in front of this group of sub-sections. Of course, the reverse is also possible, i.e. the section starts with the weights “2:1:4” and further weights are appended after this group.

According to one embodiment of the invention, the sections are arranged in N groups of sub-sections, each group having ascending weights 2⁰, 2¹, . . . , 2ⁿ, where n ranges from 1 to N, the groups being arranged in descending order, with the largest group (with n=N) first. Of course, the same effect is achieved if the groups have descending weights and are arranged in ascending order, i.e. in completely reverse order as compared with the above embodiment. Choosing the weights according to this scheme makes it possible to code 2^{N+2}−N−3 levels with (N+3)*N/2 sub-sections.

The sub-sections can further be arranged in such a way that the middle one of the selectable sequences of sub-sections corresponds as much as possible with the middle of the section period. By such an arrangement, the spatio-temporal artifacts are reduced, especially in the case of sub-field operated displays.

According to a preferred embodiment, the sub-sections are arranged in two consecutive groups, one in descending order, and one in ascending order. By this arrangement, the sub-sections with the largest weights are spread out over a first half and a second half of the section period, ensuring that the middle of the selected sequence of adjacent sub-section periods for each gray level approximately corresponds to the middle of the section period.

In such an arrangement, it is possible to ensure that, for each pixel that has to emit light during a frame period, at least the shortest sub-section is activated during the first half of the section period. This feature makes it possible to arrange for the pixels to be turned ON during the first half of the section period comprising sub-sections belonging to the first group of the two consecutive groups, and to be turned OFF during the second half of the section period comprising sub-sections belonging to the second group.

As mentioned above, each sequence selected for a non-zero gray level includes at least one sub-section in the ON-group, and this means that a pixel is turned ON once sometime during the first half of the section period, and turned OFF once sometime during the second half of the section period. This makes it possible to make the addressing more efficient, as there are fewer switching ON and OFF operations resulting in switching losses, and/or there is less time needed for addressing.

Further, the sub-section weights are preferably chosen so that the range of gray levels forms an inverse gamma curve. This has the advantage that the range of gray levels is adapted to the sensitivity of the human visual transfer system.

These and other aspects of the invention will be apparent from and elucidated with reference to the appended drawings, in which:

FIG. 1 shows coding of the gray levels 4, 5 and 6 with a pure pulse width modulation coding scheme;

FIG. 2 shows coding of the gray levels 4, 5 and 6 with a binary weighted sub-line coding scheme;

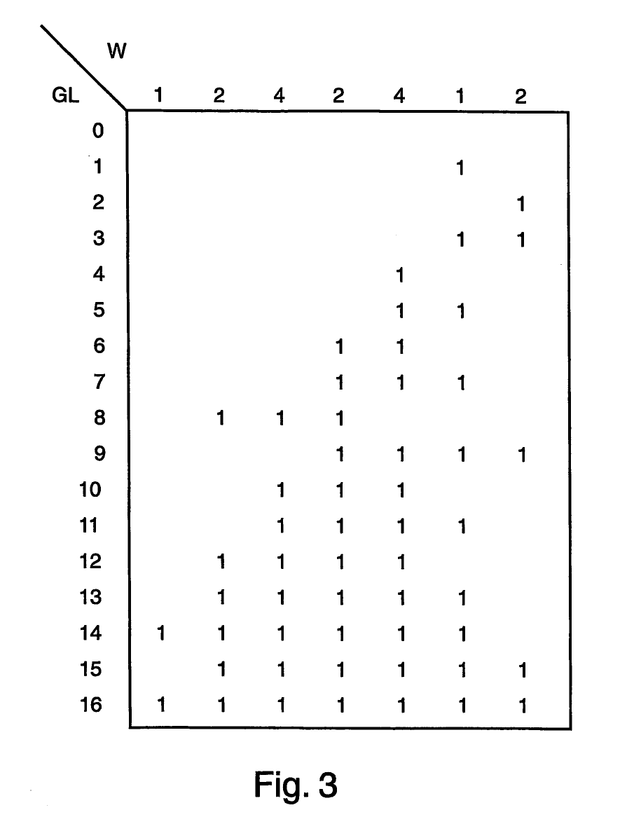

FIG. 3 shows an example of a coding scheme according to a first embodiment of the invention;

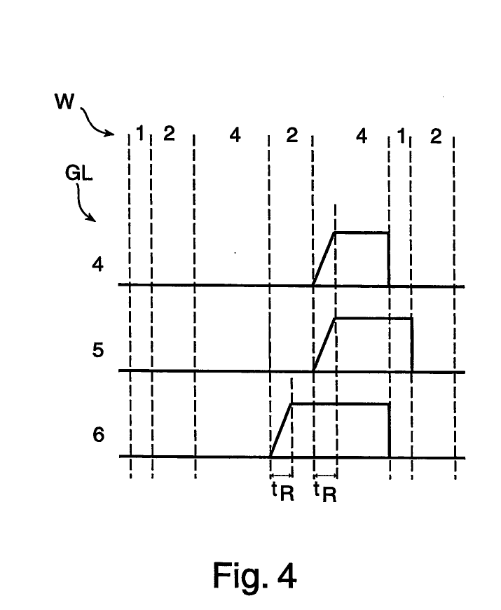

FIG. 4 shows coding of the gray levels 4, 5 and 6 with the coding scheme of FIG. 3;

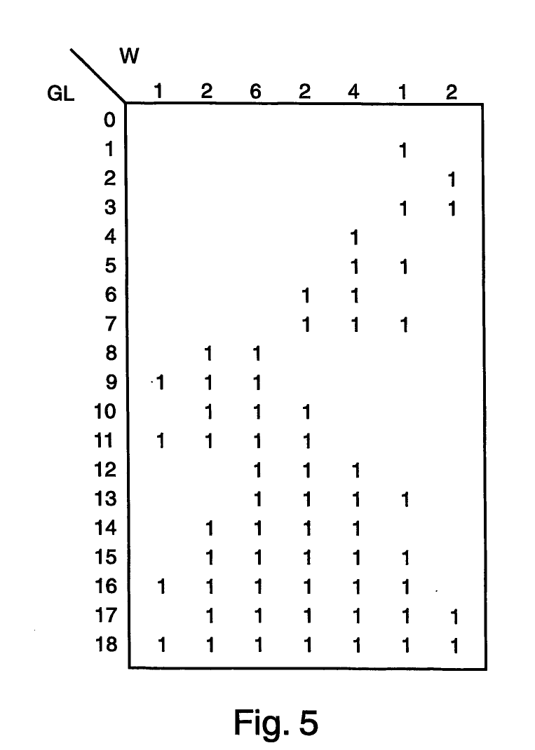

FIGS. 5, 6 and 7 show further examples of coding schemes according to the first embodiment of the invention;

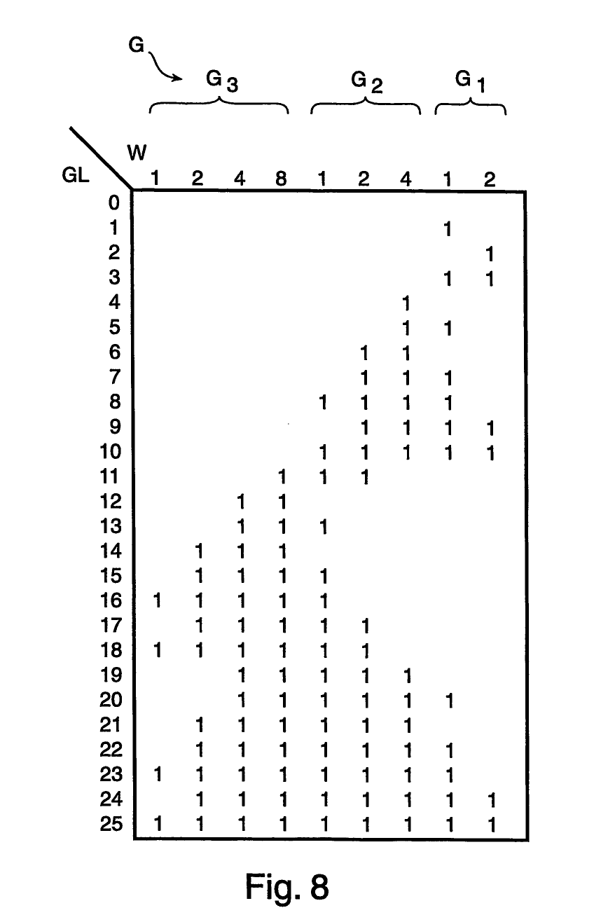

FIG. 8 shows an example of a coding scheme according to a second embodiment of the invention;

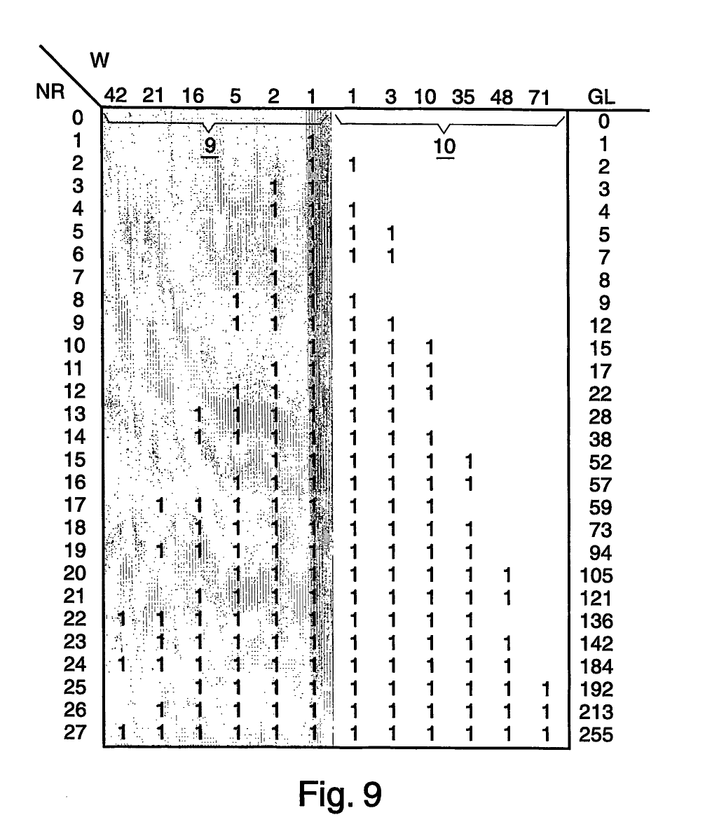

FIG. 9 shows an example of a coding scheme according to a third embodiment of the invention;

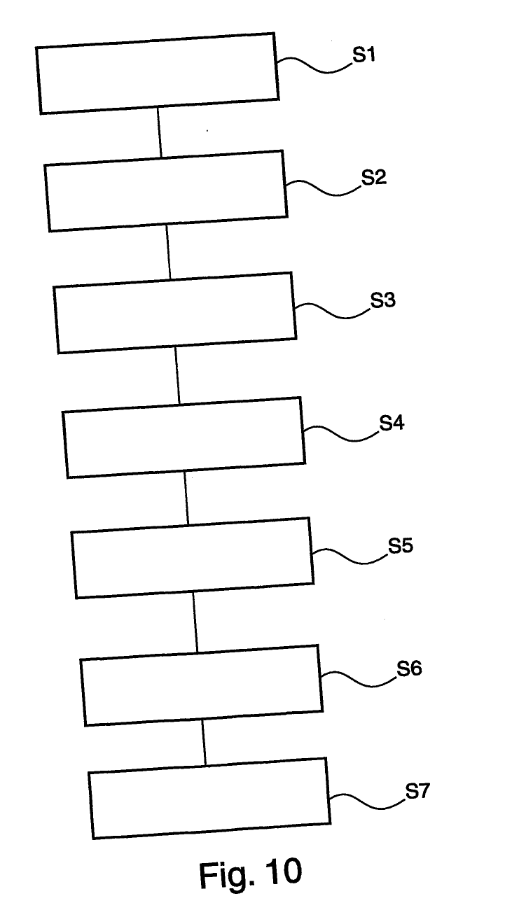

FIG. 10 is a flow chart illustrating how the coding scheme in FIG. 8 is designed;

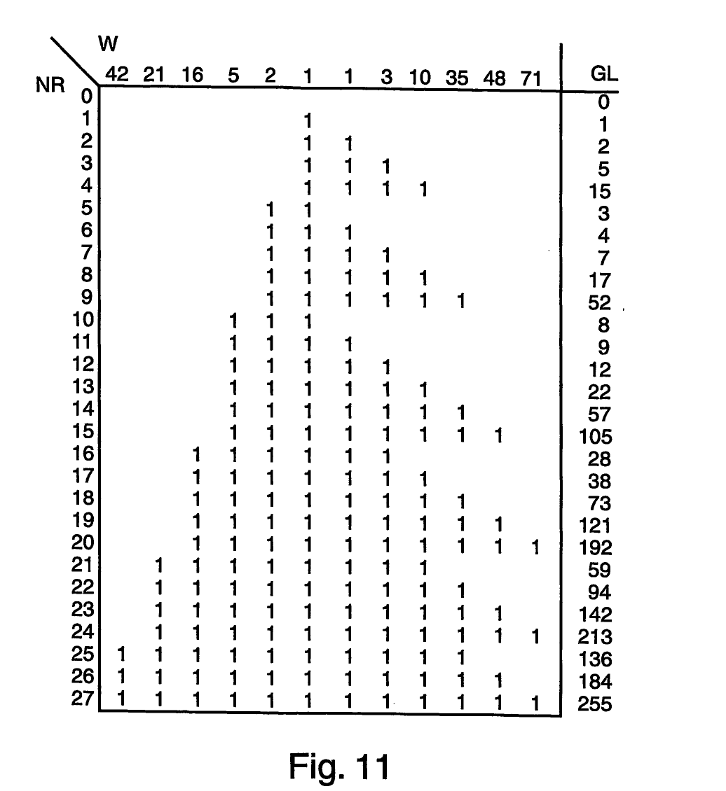

FIG. 11 shows the coding scheme in FIG. 8 under construction;

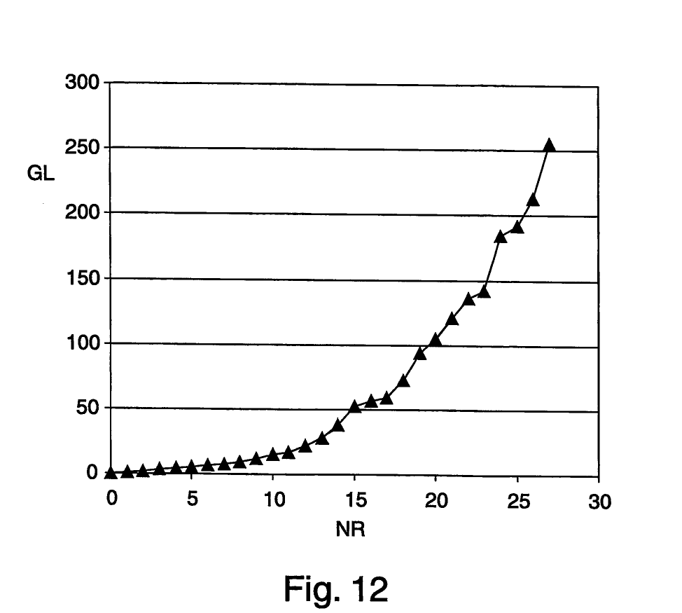

FIG. 12 is a diagram of light output vs gray level number for the coding scheme in FIG. 9;

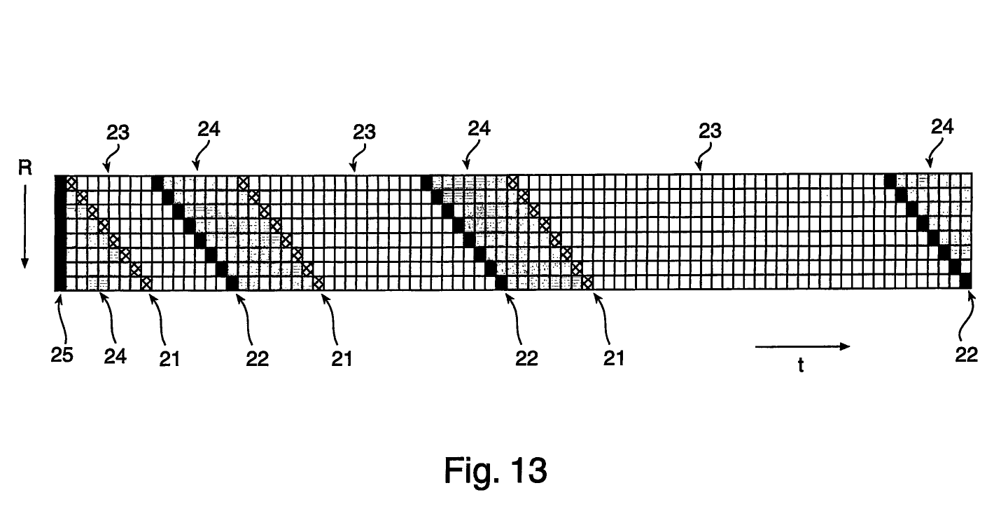

FIG. 13 shows AWD addressing according to the prior art;

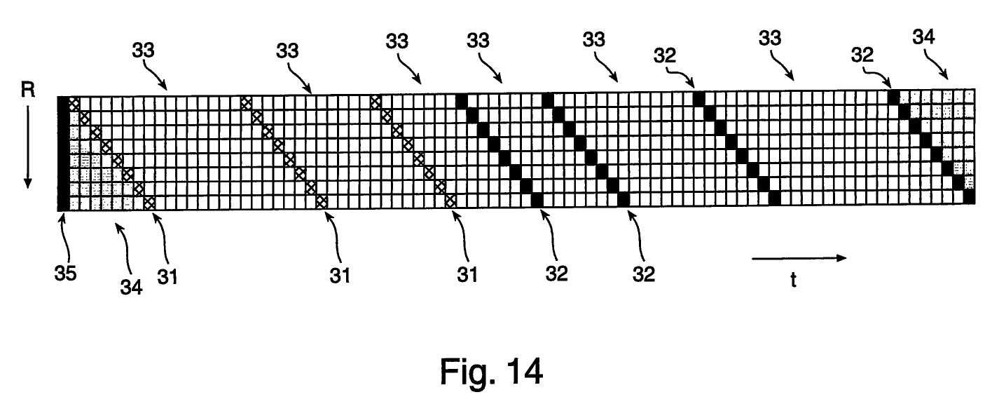

FIG. 14 shows AWD addressing with the coding scheme of FIG. 9;

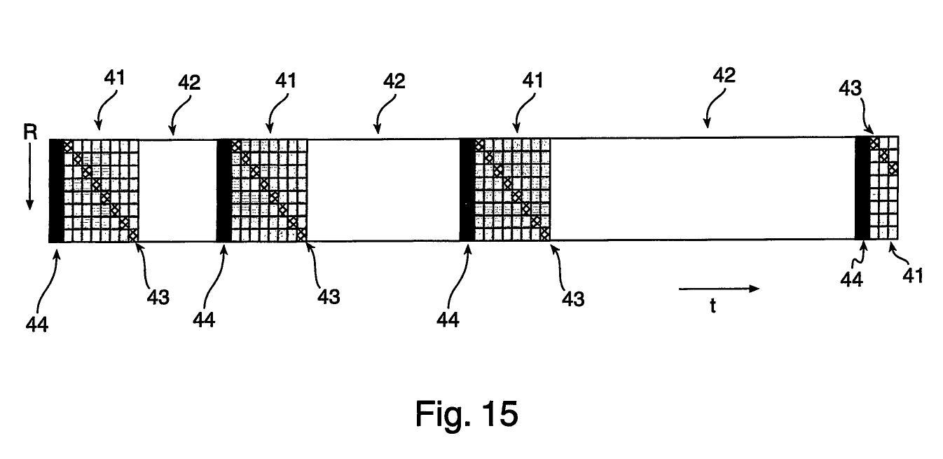

FIG. 15 shows AWD addressing according to the prior art; and

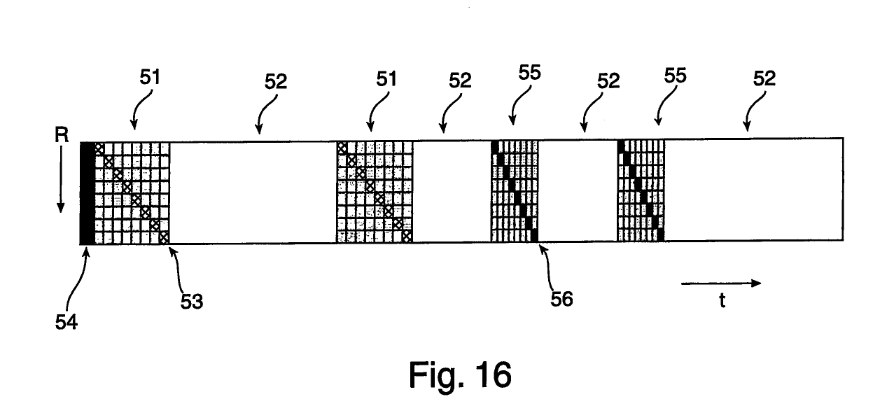

FIG. 16 shows ADS addressing with the coding scheme of FIG. 9, having groups of ON- and OFF-addressing sub-fields.

A first embodiment of the invention is illustrated in FIGS. 3-7. The coding schemes in these examples are designed starting from a group of sub-fields with a respective weight W of 4-1-2 in the far right of FIG. 3. In the coding scheme in FIG. 3, the series of sub-fields is then continued (from right to left) with a weight W of 2-4-2-1. This results in a coding scheme where 7 sub-fields are used to generate 17 different gray levels GL on a linear scale from 0 to 16. Note that all gray levels GL are composed of adjacent sub-fields, and that the resulting addressing periods will have varying starting/ending points. This is illustrated in FIG. 4, showing the generation of the gray levels GL having a value 4, 5 and 6. Thus, in the case of e.g. PLED displays, only one rise time t_{R} is required for each frame, irrespective of the gray level GL to be generated.

One should note that in contrast to a pure pulse width modulation (PWM) scheme according to FIG. 1, at some transitions between two subsequent gray levels GL more than one sub-field can change value.

An alternative example is illustrated in FIG. 5. By changing the weight W of the third sub-field from 4 to 6, the number of linear gray levels has here been increased to 19 (0 to 18), while all inventive characteristics remain.

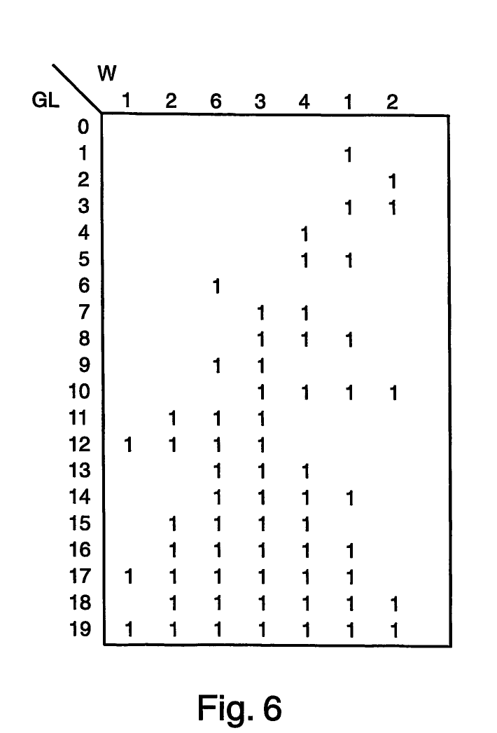

If the weight W of the fourth sub-field is increased to 3 instead of 2, as illustrated in FIG. 6, 20 linear gray levels GL can be obtained, while the inventive characteristics still remain unchanged.

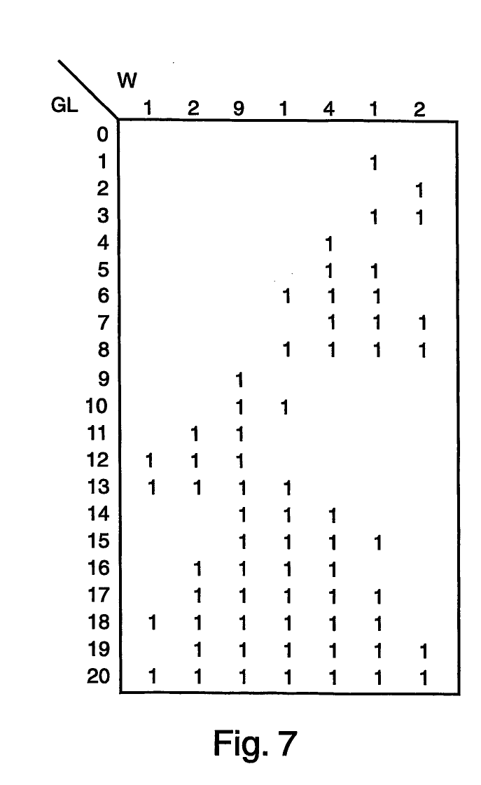

If the weight W of the fourth sub-field is instead reduced to 1, the third sub-field can be increased even further, to 9, as illustrated in FIG. 7. This linear coding scheme with 7 sub-fields thus has 21 obtainable gray levels GL, each only requiring one rise time.

A coding scheme according to a second embodiment of the invention, having similar characteristics but designed in a slightly different way, is shown in FIG. 8. In this case, the sub-fields are arranged in a plurality of groups G, indicated by G₁, G₂, G₃ in FIG. 8, and each group G has ascending weights 2⁰, 2¹, . . . , 2ⁿ, where n is an integer ranging from 1 in the rightmost group to N in the leftmost group. Choosing the weights W according to this scheme makes it possible to code 2^{N+2}−N−3 gray levels GL with (N+3)*N/2 sub-fields. In the illustrated example, N is equal to 3, so that the first group G₁ comprises the weight values “1 2”, the second group G₂ comprise the values “1 2 4”, and the third group G₃ comprises the values “1 2 4 8”. This coding scheme results in 26 gray levels GL using 9 sub-fields.

Through this more formalized design, it is possible to extend the coding scheme according to the invention to any number of gray levels GL desired.

A third embodiment of the invention is illustrated in the coding scheme in FIG. 9. In this embodiment the weights W have been chosen in such a way that a non-linear scheme of potential gray levels GL is available. The number NR of different levels is 28, approximately the same as in the embodiment of FIG. 8. However, the range of gray levels is much larger, that is from 0 to 255. With reference to FIG. 10, this coding scheme is built in the following way:

First, in step S1, the frame is divided into two groups 9, 10 of sub-fields, preferably each comprising with the same number of sub-fields. The first group 9 is given descending weights W from the beginning of the frame to the middle (step S2), and the second group 10 is given ascending weights W from the middle to the end of the frame (step S3). At this point, the exact value of the weights W is not decided.

In step S4, contiguous selections of sub-fields in the first group 9 are formed, all ending with the last sub-field in the group. Then, for each selection, a group of contiguous selections of sub-fields from the second group 10 is appended, each selection starting with the first sub-field in the group. This creates, as an intermediate result, the shape in FIG. 11, with one large triangle on the left hand side, and a number of smaller triangles on the right hand side. Note that a limitation has been introduced; the number of sub-fields from one group should not exceed the number of sub-fields, from the other group by more than two.

Then, in step S5, the gray scale level corresponding to each combination is calculated and in step S6 the levels are sorted in increasing order to obtain the “Christmas tree” code table shown in FIG. 9.

Finally, in step S7, the sub-field weights can be chosen such that the gray levels GL are distributed on an (approximately) exponential curve with an exponent of around two to three, see FIG. 12. This is approximately the inverse exponent of the human visual system, such that a (approximate) perceptual uniform scale results.

According to this embodiment, the light emission period within a frame is located approximately in the middle of the frame period. For most gray levels, the center of gravity of the light generation is thus close to the middle of the frame period. This reduces spatio-temporal artifacts as compared to schemes where the center of gravity can vary from the very beginning to the end of the frame.

Although several sub-field changes can occur between adjacent gray levels GL, this does not result in severe contouring, since the number of sub-field changes still is limited to two within each of the groups. Also in this embodiment the number of rise times for each gray level GL are equal.

As can be seen from FIG. 9, every non-zero gray level addressing period includes at least one sub-field from the first group 9, namely the “1”. This feature makes it advantageous to arrange for ON-addressing during the first half of the addressing period, corresponding to the first group 9 of sub-fields, and for OFF-addressing during the second half This will be referred to as a fourth embodiment of the invention.

While being useful also in sub-line addressing, the fourth embodiment has additional advantages in sub-field addressing. As opposed to sub-line addressing, where a display is addressed and generates light for one line at a time, e.g. a passive matrix PLED display, sub-field addressing refers to the situation where after (addressing lines successively) light generation is performed for the whole display simultaneously, e.g. plasma displays or dynamic foil displays.

There are basically two different ways to implement sub-field addressing:

Address-while-display (AWD) where addressing of some pixels is performed during light generation of other pixels. This is more efficient, but generally complicated and less robust than ADS.

Address-display-separated (ADS) where each frame is separated in addressing periods and light generation periods. This is simpler to implement, but is not as efficient as AWD.

1. Address-While-Display

In AWD, typical for e.g. dynamic foil displays, the addressing is done by first setting the row voltage to a value at which the pixels on the row can be ON-addressed, or to a value at which they can be OFF-addressed, while the other rows are at the so called unselect voltage (i.e. their pixels will not switch, independent of the data voltage). An illustration of prior art AWD addressing is given in FIG. 13. FIG. 13 shows eight rows R of a display in the vertical direction, while in the horizontal direction the addressing and light emission of these rows R as a function of time t is shown, each block representing a time period. As can be seen from FIG. 13, addressing requires two scans for each sub-field: an ON-scan 21 and an OFF-scan 22. Each ON-scan 21 introduces a light emitting period 23, and each OFF-scan 22 terminates this period. In between consecutive OFF- and ON-scans there is an unused period 24. A frame period is started with a robust all-OFF addressing 25.

AWD addressing with a coding scheme according to the fourth embodiment of the invention is illustrated in FIG. 14. Again, a frame is started with a robust all-off addressing 35. Any ON-addressing 31 will occur during the first group 9 of sub-fields, and any OFF-addressing 32 during the second group 10. Therefore, only one scan per sub-field is needed, this scan setting an ON-addressing voltage during the first group 9 of sub-fields, and an OFF-addressing voltage during the second group 10 of sub-fields. Thus, the unused periods occurring in the prior art are eliminated, and the light emitting periods 33 cover the entire frame (except for minor periods 34 at the beginning and the end of the frame period).

This reduces the number of voltage changes on the row electrodes, especially the number of large voltage changes (in e.g. a foil display, the voltage change from ON to OFF is typically a factor of two larger than that from ON to unselect or from OFF to unselect).

2. Address-Display-Separated

Prior art ADS addressing, as performed in e.g. a plasma display, is illustrated in FIG. 15. The frame period is divided into addressing periods 41, and weighted light emitting periods 42. The addressing is normally performed as ON-addressing 43, and each ON-addressing is preceded by an erase action 44. Usually, the first erasure of a frame is of a so-called hard and priming nature, in which all cells are erased very reliably and independent of their history. The other erasures (soft erase) in the frame are usually of a soft nature, which works reliably in combination with one hard erasure per frame. Further, the time required to perform ON-addressing is longer if the pixel has been turned off a longer period of time. Thus, the addressing of the first active sub-field of the frame will require slightly more time. With binary weighted coding, this first addressing can occur at any sub-field, and therefore each addressing period 43 must be adapted to this longer time period.

ADS addressing with coding according to the fourth embodiment of the invention is illustrated in FIG. 16. As in prior art addressing, the frame is preceded by an erase action 54. The remainder of the frame is then divided into addressing periods 51, 55 and light emitting periods 52. During the first part of the frame, i.e. during the first group 9 of sub-fields, the addressing 53 performed is ON-addressing. During the second part of the frame, OFF-addressing 56 is performed, and the final light emitting period 52 in the first group will act as an “all-ON” state. Any pixel that will be turned ON at any time during the frame, i.e. all pixels having to display a non-zero gray level GL, will be turned ON during this light emitting period.

As the negative addressing 56 can be performed significantly faster (up to 50%), the OFF-addressing periods 55 are shorter than the ON-addressing periods 51, thus resulting in a shorter total addressing time than for conventional binary weighted coding, allowing a larger number of sub-fields.

Coding schemes according to the invention can also advantageously be used in other types of displays, such as Digital Mirror Devices, where a reflective mirror is tilted over approx. ±10 degrees to obtain in a black or light state, and displays with so-called iMoD (interferometric modulator) architecture, where a metal film is electrostatically driven to change an air gap size, such as to switch between a highly reflective state and a black state.

Coding schemes according to the invention can be advantageously used in any passive matrix displays such as PLED displays and FED displays.

It is evident that a person skilled in the art will be able to determine additional coding schemes within the scope of the present invention. For example, any example given above may be reversed without changing the effect thereof. Also, a number of minor adjustments may be made to the given examples without departing from the inventive concept. As a particular case, in the fourth embodiment of the invention the number of sub-fields and their weights may be varied as found suitable by a person skilled in the art.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method for driving pixels in a display device with an image signal, the image signal comprising gray level information of an image to be rendered by the display device, the method comprising:
dividing the image signal into sections, each section having a duration of a section period;
dividing the section period into a plurality of adjacent, weighted sub-section periods;
selecting for each of the pixels to be driven during the section period a sequence of adjacent sub-section periods in dependence on the gray level information, the selectable sequences lacking a common starting and ending point;
driving the pixels during the sequences of adjacent sub-section periods.

2. A method according to claim 1, wherein the weighted sub-section periods are chosen so as to enable a selection of a range of substantially linearly increasing sequences of adjacent sub-section periods.

3. A method according to claim 2, wherein a difference between any two subsequent sequences in the range is substantially equal to the weight of the shortest of the plurality of sub-segment periods.

4. A method according to claim 3, wherein the three final sub-sections in the section periods have relative weights “4:1:2”.

5. A method according to claim 4, wherein the weights of the sub-sections are chosen to be one of the following combinations: “1:2:4:2:4:1:2”, “1:2:6:2:4:1:2”, “1:2:6:3:4:1:2” and “1:2:9:1:4:1:2”.

6. A method according to claim 3, wherein the sub-sections are arranged in N groups, an n-th group having n+1 sub-sections with ascending weights 2⁰, 2¹, . . . , 2ⁿ, with index n ranging from 1 to N, the N groups being arranged in descending order, with the group having the largest index first.

7. A method according to claim 1, wherein the sub-sections are arranged in two adjacent groups, a first group of the two groups having sub-sections in descending order, and a second group of the two groups having sub-sections in ascending order.

8. A method according to claim 7, wherein a middle of each of the selectable sequences of sub-sections is close to a middle of the section period.

9. A method according to claim 7, wherein the pixels which have to be driven to emit light are turned on during the first group of sub-sections, and are turned off during the second group of sub sections.

10. A method according to claim 7, wherein the sub-section weights are chosen such that the weights of subsequent, selectable sequences substantially form an exponential curve.

11. A sub-field-operated display device having a display; and using the method of claim 1.

12. A sub-line-operated display device having a display; and using the method of claim 1.
